(19) United States
(12) Patent Application Publication
(10) Pub. No.: US 2007/0109982 A1
(43) Pub. Date: May 17, 2007

(54) Method and system for managing ad-hoc connections in a wireless network

(75) Inventors: Srinivas Gudipudi, Nacharam (IN); Rohit Shankar, Madhapur (IN); Abhilash V. Purushothaman, Kerala (IN); Ravi R. Pore, Pune (IN); Sumit B. Deshpande, Central Islip, NY (US); Yidong Zhu, Lincolnshire, IL (US); Theodore Short, Jacksonville, FL (US); Tuna Djemil, East Northport, NY (US)

Correspondence Address: BAKER BOTTS L.L.P., 2001 ROSS AVENUE, SUITE 600, DALLAS, TX, 75201-2980, US

(73) Assignee: Computer Associates Think, Inc., Islandia, NY (US)

(21) Appl. No.: 11/466,300

(22) Filed: Aug. 22, 2006

Related U.S. Application Data
(60) Provisional application No. 60/735,690, filed on Nov. 11, 2005.

(51) Int. Cl. H04B 7/00

(52) U.S. Cl. 370/310.2

(57) ABSTRACT

According to one embodiment of the invention, a method for managing ad-hoc connections in a wireless network includes receiving, at an endpoint device, a connection policy from a managing device over the wireless network. The connection policy indicates network security settings for the endpoint device. The method also includes detecting at the endpoint device an ad-hoc connection. The method further includes responding to the ad-hoc connection based on the connection policy.

### CROSS REFERENCE TO RELATED APPLICATIONS

This application claims the benefit of priority under 35 U.S.C. § 119(e) of U.S. Provisional Patent Application Ser. No. 60/735,690 entitled “SECURE AND MANAGEABLE WIRELESS COMPUTING SYSTEMS AND METHODS,” which was filed on Nov. 11, 2005.

### TECHNICAL FIELD OF THE INVENTION

This invention relates generally to wireless networks, and more particularly to a method and system for managing ad-hoc connections in a wireless network.

### BACKGROUND OF THE INVENTION

Wireless networks may consist of collections of devices, capable of communicating with each other, and forming a dynamically changing ad-hoc network. An ad-hoc network is a point-to-point network configuration that establishes a connection between devices. However, ad-hoc networks may present security risks because they typically do not employ measures to authenticate devices. That is, any device within range can connect to other devices configured to allow ad-hoc networking. Thus, ad-hoc connectivity may render devices susceptible to attackers attempting to gain unauthorized access. It is generally desirable to minimize unauthorized access in wireless networks.

### OVERVIEW OF EXAMPLE EMBODIMENTS

According to one embodiment of the invention, a method for managing ad-hoc connections in a wireless network includes receiving, at an endpoint device, a connection policy from a managing device over the wireless network. The connection policy indicates network security settings for the endpoint device. The method also includes detecting at the endpoint device an ad-hoc connection. The method further includes responding to the ad-hoc connection based on the connection policy.

Technical advantages of particular embodiments of the present invention include a method and system for managing ad-hoc connections in a wireless network that automatically denies any ad-hoc network connection. Thus, a connection policy prevents unauthorized access to an endpoint device.

Another technical advantage of particular embodiments of the present invention includes a method and system for managing ad-hoc connections in a wireless network that alerts a user of any ad-hoc network connection. Accordingly, a user is informed of the ad-hoc connection and may permit the ad-hoc connection at the user's discretion.

Other technical advantages of the present invention will be readily apparent to one skilled in the art from the following figures, descriptions, and claims. Moreover, while specific advantages have been enumerated above, various embodiments may include all, some, or none of the enumerated advantages.

### BRIEF DESCRIPTION OF THE DRAWINGS

For a more complete understanding of the present invention and its features and advantages, reference is now made to the following description, taken in conjunction with the accompanying drawings, in which:

FIG. 1 illustrates a system that incorporates aspects of the present invention;

FIG. 2 is a simplified diagram of an example network that includes a device within range of an ad-hoc network; and

FIG. 3 is a flow diagram for managing ad-hoc connections in a wireless network.

### DESCRIPTION OF EXAMPLE EMBODIMENTS

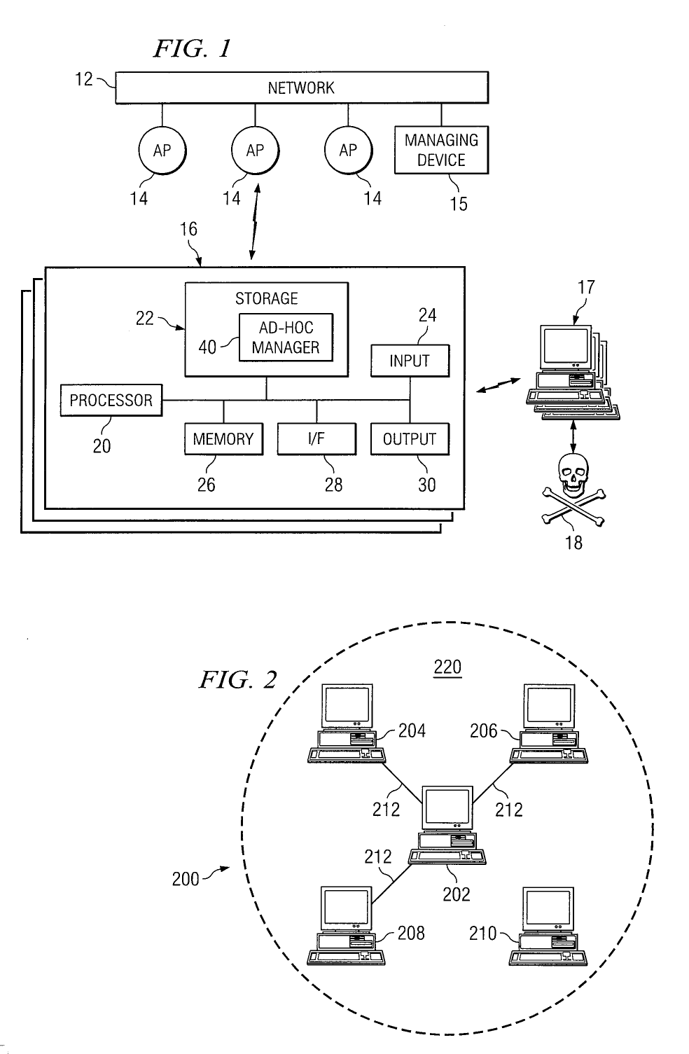

Embodiments of the present invention and its advantages are best understood by referring to FIGS. 1 through 3 of the drawings, like numerals being used for like and corresponding parts of the various drawings.

FIG. 1 illustrates one embodiment of a system 10 for managing ad-hoc connections in a wireless network. As shown in FIG. 1, system 10 generally includes a network 12, one or more wireless access points 14, a managing device 15, one or more endpoint devices 16, and one or more ad-hoc devices 17. System 10 is particularly adapted for detecting an ad-hoc connection and responding to the ad-hoc connection based on a connection policy.

Network 12 may refer to any interconnecting system capable of transmitting audio, video, signals, data, messages, or any combination of the preceding. Network 12 may comprise all or a portion of a public switched telephone network (PSTN), a public or private data network, a local area network (LAN), a metropolitan area network (MAN), a wide area network (WAN), a local, regional, or global communication or computer network such as the Internet, a wireline or wireless network, an enterprise intranet, other suitable communication link, or any combination of the preceding.

Network 12 may transmit information in packet flows in one embodiment. A packet flow includes one or more packets sent from a source to a destination. A packet may comprise a bundle of data organized in a specific way for transmission, and a frame may comprise the payload of one or more packets organized in a specific way for transmission. A packet-based communication protocol such as Internet Protocol (IP) may be used to communicate the packet flows.

A packet flow may be identified in any suitable manner. As an example, a packet flow may be identified by a packet identifier giving the source and destination of the packet flow. A source may be given by an address such as the IP address, port, or both. Similarly, a destination may be given by an address such as the IP address, port, or both.

Network 12 may utilize protocols and technologies to transmit information. Example protocols and technologies include those described by the Institute of Electrical and Electronics Engineers, Inc. (IEEE) 802.xx standards such as 802.11, 802.16, or WiMAX standards, the International Telecommunications Union (ITU-T) standards, the European Telecommunications Standards Institute (ETSI) standards, Internet Engineering Task Force (IETF) standards, the third generation partnerships project (3GPP) standards, or other standards.

Access point 14 may be any network point suitable to couple a wireless device, such as endpoint device 16, to a network, such as network 12. According to one embodiment of the invention, access point 14 may have a wired connection to network 12. According to another embodiment of the invention, access point 14 may have a wireless connection to network 12. According to another embodiment of the invention, access point 14 may include a receiver or transmitter or both a receiver and a transmitter. As an example, access point 14 may include an omni-directional antenna operable to communicate with one or more endpoints.

In particular embodiments of the invention, communications between access point 14 and endpoint device 16 are communicated according to one or more secure wireless communication protocols or WLAN protocols, such as portions or all of the Wired Equivalent Privacy (WEP) protocol, the Robust Security Network (RSN) associated with the IEEE 802.11i protocol, the IEEE 802.1x protocol, the Advanced Encryption Standard (AES), the Temporal Key Integrity Protocol (TKIP), Extensible Authentication Protocol over LAN (EAPOL) algorithms or protocols (such as EAP-TTLS, PEAP, or CISCO's LEAP or EAP-FAST protocols, for example), WiFi Protected Access (WPA) protocol, WiFi Protected Access Pre-shared key (WPA-PSK) protocol, WiFi Protected Access Version 2 (WPA2) protocol, or WiFi Protected Access Version 2 Pre-shared key (WPA2-PSK) protocol, for example.

Managing device 15 represents any device suitable to transmit a connection policy to endpoint device 16. According to one embodiment, managing device 15 may transmit a connection policy by transmitting software code that configures endpoint 16 according to the instructions in the connection policy. Although FIG. 1 provides one example of managing device 15 as operating within network 12, in other embodiments managing device 15 may operate as a wireless device connecting to network 12 through an access point 14.

Endpoint device 16 may refer to any suitable device operable to communicate with network 12 through an access point 14. Endpoint device 16 may execute with any of the well-known MS-DOS, PC-DOS, OS-2, MAC-OS, WINDOWS™, UNIX, or other appropriate operating systems, including future operating systems. Endpoint device 16 may include, for example, a personal digital assistant, a computer such as a laptop, a cellular telephone, a mobile handset, or any other device operable to communicate with network 12 through access point 14. Additional details of one example endpoint device 16 are described below.

Ad-hoc device 17 may refer to any suitable device operable to communicate with endpoint device 16 using an ad-hoc network. Ad-hoc device 17 may include, for example, a personal digital assistant, a computer such as a laptop, or any other device operable to communicate with endpoint device 16 using an ad-hoc network. An ad-hoc network may refer to any point-to-point network configuration that establishes a connection directly between devices. As an example, ad-hoc enabled devices may attempt to discover other devices within a wireless range, and attempt to form a network between those devices.

In various embodiments of the invention, an attacker 18 may use ad-hoc device 17 to attempt to create an ad-hoc network with endpoint device 16. Ad-hoc connectivity may allow attacker 18 to gain unauthorized access to endpoint device 16 without informing a user of endpoint device 16.

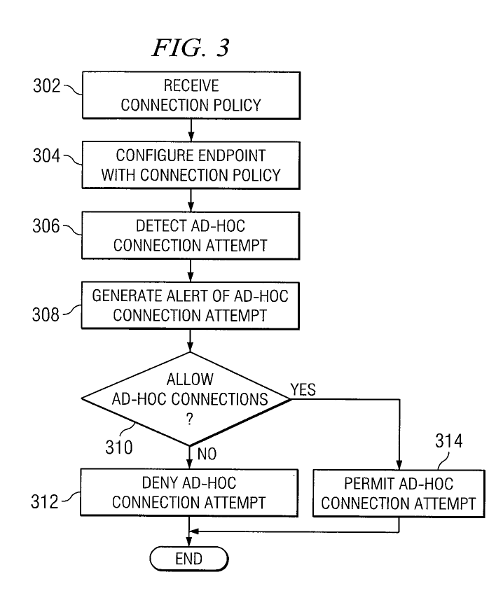

According to one embodiment of the invention, a system and method are provided that alert a user of an endpoint device of an ad-hoc connection. Thus, a user can take measures to prevent an unauthorized connection from being established. Alternatively, a connection policy at the endpoint device may automatically prevent ad-hoc connections. This is effected by receiving a connection policy at an endpoint device on a wireless network and configuring the endpoint device to respond to an ad-hoc connection based on the connection policy. Additional details of example embodiments of the invention are described in greater detail below in conjunction with portions of FIG. 1, FIG. 2, and FIG. 3.

According to the illustrated embodiment of the invention, endpoint device 16 includes a processor 20, a storage device 22, an input device 24, a memory device 26, a communication interface 28, an output device 30, and an ad-hoc manager 40.

Processor 20 may refer to any suitable device operable to execute instructions and manipulate data to perform operations for endpoint device 16. Processor 22 may include, for example, any type of central processing unit (CPU).

Storage device 22 may refer to any suitable device operable for storing data and instructions. Storage device 22 may include, for example, a magnetic disk, flash memory, or optical disk, or other suitable data storage device.

Input device 24 may refer to any suitable device operable to input, select, and/or manipulate various data and information. Input device 24 may include, for example, a keyboard, mouse, graphics tablet, joystick, light pen, microphone, scanner, or other suitable input device.

Memory device 26 may refer to any suitable device operable to store and facilitate retrieval of data, and may comprise Random Access Memory (RAM), Read Only Memory (ROM), a magnetic drive, a disk drive, a Compact Disk (CD) drive, a Digital Video Disk (DVD) drive, removable media storage, any other suitable data storage medium, or a combination of any of the preceding.

Communication interface 28 may refer to any suitable device operable to receive input for endpoint device 16, send output from endpoint device 16, perform suitable processing of the input or output or both, communicate to other devices, or any combination of the preceding. Communication interface 28 may include appropriate hardware (e.g. modem, network interface card, etc.) and software, including protocol conversion and data processing capabilities, to communicate through a LAN, WAN, or other communication system that allows endpoint device 16 to communicate to other devices. Communication interface 28 may include one or more ports, conversion software, or both.

Output device 30 may refer to any suitable device operable for displaying information to a user. Output device 30 may include, for example, a video display, a printer, a plotter, or other suitable output device.

Ad-hoc manager 40 may refer to any suitable logic embodied in computer-readable media, and when executed, operable to receive a connection policy from managing device 15, and configure endpoint device 16 to detect and respond to ad-hoc connections based on the connection policy. In the illustrated embodiment of the invention, ad-hoc manager 40 resides in storage device 22. In other embodiments of the invention, ad-hoc manager 40 may reside in memory device 26, or any other suitable device operable to store and facilitate retrieval of data and instructions.

According to one embodiment of the invention, a connection policy provided by managing device 15 may include various levels of security. For example, a connection policy may include a “High Security,” “Medium Security,” or “Low Security” policy. Each level of security corresponds to the type of network connectivity that is enabled. For example, for a “High Security” connection policy, connectivity to an ad-hoc network may be prevented. As another example, for a “Low Security” connection policy, connectivity to an ad-hoc network may be allowed. However, the present disclosure contemplates many types of levels and network types to represent a connection policy for endpoint device 16. Various embodiments may include some, all, or none of the enumerated levels.

According to one embodiment of the invention, ad-hoc manager 40 may receive a connection policy from managing device 15, and configure endpoint device 16 according to the connection policy by configuring communication interface 28. For example, if the connection policy prevents ad-hoc connections, ad-hoc manager 40 may configure communication interface 28 to automatically deny all ad-hoc connections. As another example, if the connection policy allows ad-hoc connections, ad-hoc manager 40 may display an alert to output device 30 of a detected ad-hoc connection, and allow a user to permit the ad-hoc connection at the user's discretion

FIG. 2 is a simplified diagram of an example network 200. As shown in FIG. 2, network 200 generally includes a wireless range 220 and five devices 202, 204, 206, 208, and 210. Device 210 may be substantially similar to endpoint device 16 of FIG. 1, and device 202 may be substantially similar to ad-hoc device 17 of FIG. 1. According to one embodiment of the invention, device 210 may have a connection policy configured to respond to an ad-hoc connection.

According to the illustrated embodiment, device 202 is connected to devices 204, 206, and 208 by a plurality of ad-hoc network connections 212. According to one embodiment, device 210 may enter wireless range 220 and detect an ad-hoc connection from device 202. In various embodiments, device 210 may be configured to automatically deny the ad-hoc connection. In other embodiments, device 210 may be configured to generate an alert to a user of device 210 of the ad-hoc connection. The user of device 210 may permit the ad-hoc connection upon receiving the alert, creating an ad-hoc connection 212 between device 202 and 210.

FIG. 3 is a flow diagram illustrating example acts associated with managing ad-hoc connections in a wireless network. At step 302, a connection policy is received by an endpoint device in the ad-hoc connection managing system. In particular embodiments of the invention, the connection policy may include various levels of security, defining the types of connections allowed at the endpoint device. The connection policy security level may range from “High Security,” to “Medium Security,” to “Low Security,” or other similar measurements.

At step 304, the endpoint device is configured by the connection policy. In particular embodiments of the invention, the connection policy may include software code operable to configure the endpoint device.

At step 306, an ad-hoc connection is detected by the endpoint device. In particular embodiments of the invention, the ad-hoc connection may be detected from an ad-hoc network in the range of the endpoint device. In other embodiments, the ad-hoc connection may be detected directly from another device attempting to access to the endpoint device using an ad-hoc connection.

At step 308, an alert is generated for the ad-hoc connection. In particular embodiments, the alert may include information regarding the source of the ad-hoc connection.

A determination may be made at step 310 as to whether the endpoint device allows ad-hoc connections. In particular embodiments, the endpoint device may be configured to respond to the ad-hoc connection according to various security levels. For example, under a “High Security” connection policy, the endpoint device may be configured to deny the ad-hoc connection in step 312, thereby preventing potential ad-hoc connection attempts from attackers. In particular embodiments, the endpoint device may be configured to deny the ad-hoc connection without alerting the user of the ad-hoc connection. However, under a “Low Security” connection policy, the endpoint device may be configured to allow the ad-hoc connection at the discretion of a user of the endpoint device at step 314.

Although the present invention has been described in several embodiments, a myriad of changes, variations, alterations, transformations, and modifications may be suggested to one skilled in the art, and it is intended that the present invention encompass such changes, variations, alterations, transformations, and modifications as falling within the spirit and scope of the appended claims.

What is claimed is:

1. A method for managing ad-hoc connections in a wireless network, comprising:
receiving, at an endpoint device, a connection policy from a managing device over the wireless network, the connection policy indicating network security settings for the endpoint device, the connection policy comprising software code operable to configure the endpoint device;
configuring the endpoint device according to the connection policy;
detecting, at the endpoint device, an ad-hoc connection;
generating an alert of the ad-hoc connection; and
in response to a designation by a user of the endpoint device, permitting an ad-hoc connection in response to the ad-hoc connection.

2. A method for managing ad-hoc connections in a wireless network, comprising:
receiving, at an endpoint device, a connection policy from a managing device over the wireless network, the connection policy indicating network security settings for the endpoint device;
detecting, at the endpoint device, an ad-hoc connection; and
responding to the ad-hoc connection based on the connection policy.

3. The method of claim 2, further comprising configuring the endpoint device according to the connection policy.

4. The method of claim 2, further comprising detecting, at the endpoint device, an ad-hoc network.

5. The method of claim 2, wherein responding to the ad-hoc connection comprises generating an alert of the ad-hoc connection.

6. The method of claim 5, further comprising in response to a designation by a user of the endpoint device, permitting an ad-hoc connection in response to the ad-hoc connection.

7. The method of claim 2, wherein responding to the ad-hoc connection comprises denying the ad-hoc connection.

8. The method of claim 2, wherein the connection policy comprises software code operable to configure the endpoint device.

9. A system for managing ad-hoc connections in a wireless network, comprising:
a wireless network, the wireless network comprising one or more access points;
a managing device operable to transmit a connection policy; and
an endpoint device operable to connect to the wireless network, the endpoint device comprising:
a processor; and
a storage device readable by the endpoint device, embodying a program of instructions executable by the processor to perform method steps for managing ad-hoc connections, the method steps comprising:
receiving a connection policy from the managing device over the wireless network, the connection policy indicating network security settings for the endpoint device;
detecting an ad-hoc connection; and
responding to the ad-hoc connection based on the connection policy.

10. The system of claim 9, wherein the method steps further comprise configuring the endpoint device according to the connection policy.

11. The system of claim 9, wherein the method steps further comprise detecting an ad-hoc network.

12. The system of claim 9, wherein the method step of responding to the ad-hoc connection comprises generating an alert of the ad-hoc connection.

13. The system of claim 12, wherein the method step of responding to the ad-hoc connection further comprises in response to a designation by a user of the endpoint device, permitting an ad-hoc connection in response to the ad-hoc connection.

14. The system of claim 9, wherein the method step of responding to the ad-hoc connection comprises denying the ad-hoc connection.

15. The system of claim 9, wherein the connection policy comprises software code operable to configure the endpoint device.

16. Logic encoded in media, the logic being operable to:
receive, at an endpoint device, a connection policy from a managing device over a wireless network, the connection policy indicating network security settings for the endpoint device;
detect, at the endpoint device, an ad-hoc connection; and
respond to the ad-hoc connection based on the connection policy.

17. The logic of claim 16, further operable to configure the endpoint device according to the connection policy.

18. The logic of claim 16, further operable to detect, at the endpoint device, an ad-hoc network.

19. The logic of claim 16, wherein the logic operable to respond to the ad-hoc connection comprises the logic operable to generate an alert of the ad-hoc connection.

20. The logic of claim 17, wherein the logic operable respond to the ad-hoc connection further comprises the logic operable to permit an ad-hoc connection in response to the ad-hoc connection, in response to a designation by a user of the endpoint device.

21. The logic of claim 16, wherein the logic operable respond to the ad-hoc connection comprises the logic operable to deny the ad-hoc connection.

22. The logic of claim 16, wherein the connection policy comprises software code operable to configure the endpoint device.
